(19) United States
(12) Patent Application Publication
(10) Pub. No.: US 2026/0346947 A1
(43) Pub. Date: Nov. 5, 2026

(54) Chainset for a Velocipede

(71) Applicant: 4LOWTECH, Louvain-la-Neuve (BE)

(72) Inventor: Rupert MEURICE DE DORMALE, Limelette (BE)

(73) Assignee: 4LOWTECH, Louvain-la-Neuve (BE)

(21) Appl. No.: 19/488,147

(22) PCT Filed: May 16, 2024
(86) PCT No.: PCT/EP2024/063599

§ 371 Date: Nov. 26, 2025

(30) Foreign Application Priority Data
May 31, 2023 (BE) 2023/5441

(51) Int. Cl. B62M 1/28; B62M 1/30

(52) U.S. Cl. CPC B62M 1/28; B62M 1/30

(57) ABSTRACT

The invention relates to a chainset (1) for a velocipede (10), comprising two pedals (2) which are mobile in translation (T) and mechanically decoupled.

### TECHNICAL FIELD

The invention concerns a chainset for a velocipede and a velocipede, for example a bicycle, tricycle or quadricycle, provided with such a chainset.

### PRIOR ART

The chainsets are widespread and popular mechanical devices for use on bicycles. A chainset generally comprises two pedals that are mobile in rotation about the same axis and are mechanically coupled to at least one toothed wheel, known as the “chainring”, by a crank. A chain mechanically couples this chainring to the rear wheel of the bicycle. The rotating movement of the pedals drives the rear wheel of the bicycle, and sets the whole bicycle in motion.

One shortcoming of this type of chainset is that a part of the energy supplied by a cyclist on the chainset is not converted into the rotational movement of the wheel of the bicycle. This problem is explained in detail in FIG. 3 of the patent publication FR 2 830 831 B1.

To solve this problem, this same publication proposes to do away with pedals that are mobile in rotation, as everyone knows, and replace them with pedals that can be mobile in translation, each linked to a drive train of the rear wheel in a closed cycle. In particular, the corresponding chains are connected to each other by a return means, such as a pulley. The pedalling is done by an alternating translational movement of the cyclist's legs. The return of a pedal “upwards”, i.e. to its starting point of application of thrust by one of the cyclist's legs, is achieved in particular passively mechanically when the other leg of the cyclist exerts such a thrust “downwards” on the other pedal. The two pedals are mechanically coupled to each other, with the movement of one determining the movement of the other.

As shown in FIG. 4 of the aforementioned publication, the translational pedalling is more efficient. It is also more pleasant for the cyclist than conventional rotational pedalling.

However, there is still room for improvement in terms of pedalling efficiency while retaining the pleasant nature of pedalling on the move.

### SUMMARY OF THE INVENTION

The purpose of the invention is to provide a chainset for a velocipede with two translating pedals for improved efficiency. To this end, the pedals of the chainset according to the invention are mechanically decoupled from each other.

In other words, the two pedals are mechanically decoupled from each other, i.e. they move independently of each other. By mechanically decoupling the pedals from each other, the return of a pedal “upwards” or, more generally, to a starting point for the application of thrust, is no longer conditional on the movement of the other pedal of the chainset. This return can be achieved by the user of the velocipede more quickly, five to ten times faster, actively and not passively, without any mechanical constraint associated with the position of the other pedal.

So, whereas with a conventional chainset or one based on the prior art, only one of the pedals is activated at a time, the chainset based on the present invention allows energy to be transmitted via both pedals at the same time, whether synchronised or not, and also significantly reduces the time taken for each pedal to return to its position, whether synchronised or not. This time saving can then be used to increase the amount of pedal thrust when using the velocipede, and therefore the amount of energy transmitted to one or more of the velocipede's wheels per unit of time.

The chainset therefore allows for faster and more efficient human-powered movement than the chainsets known in the prior art.

The chainset according to the invention is particularly suitable for velocipedes intended for transporting heavy loads and/or over long distances. Preferably, the chainset according to the invention comprises exactly two pedals. However, a chainset with another number of pedals, such as four or six pedals, is not excluded from the scope of the invention, for example for a tandem.

As is known to those skilled in the art, the term “velocipede” refers to a human-powered vehicle with two or more wheels. In the context of this document, the human propulsion is achieved in particular via the chainset of the invention, generally by the user's lower limbs. Well-known examples of velocipedes include the bicycle, tricycle, and quadricycle.

However, a propulsion that would be exerted by the user's upper limbs is not excluded from the scope of the invention, provided that, as will be readily understood by those skilled in the art, the chainset of the invention are arranged in an appropriate manner or that the pedals are coupled to an attachment system for their actuation by such upper limbs (for example, at the level of the user's hands). This design is particularly advantageous for users with reduced mobility in the lower limbs.

Although the following embodiments present the case of an essentially human-powered velocipede, a velocipede also comprising an auxiliary propulsion motor, for example an electric motor, is not excluded within the scope of this invention. However, the presence of such an auxiliary engine is totally optional for the implementation of the invention.

In the context of this document, as is widely known to the person skilled in the art, the term “chainset” refers to a mechanical system for converting and/or transmitting a movement (generally rotary, or in the case of the invention, translational) exerted at the pedals of this chainset into a rotary movement of a mechanical part, for example a toothed wheel, such as a bicycle chainring, which is mechanically coupled, for example via a chain, to a wheel of the velocipede.

The pedals of the chainset according to the invention are not limited by a specific shape. Any mechanical element capable of acting as a point of application for a thrust exerted by a limb (generally the lower limb) of the user can constitute a “pedal” provided that it is mechanically coupled to the rest of the chainset in an appropriate manner to perform its function.

Preferably, however, each pedal of the chainset includes a support surface for a distal segment of the limb (generally a foot) that is textured and/or padded for greater user comfort. The pedals are preferably each provided with a lateral edge and/or a flexible and/or arched and/or length-adjustable portion surmounting a support surface for the distal segment, which are intended to facilitate holding this distal segment in position. For example, a footrest. This makes it easier to carry out the aforementioned active movement of returning the pedals to position. This saves additional time in making this movement, and therefore improves the efficiency of the velocipede.

In the context of this document, the term “translation” is used to designate movement by rectilinear sliding. In particular, the movement does not rotate, turn over or distort.

The translational mobility of a pedal therefore corresponds to the fact that it can move along a straight line in two opposite directions (for example, from “top to bottom” and from “bottom to top”). Preferably, during normal operation of the chainset, the pedals can only be moved in translation. The movement exerted on the pedals of the chainset is typically back and forth along this straight line.

In the context of this document, a “mechanical coupling” between two parts refers to an interaction between these parts in their position relative to each other. In other words, for two mechanically coupled parts, at least one movement (possibly in a defined direction and sense) of one of the parts will generate a movement of the other of the parts, so that they maintain a fixed position relative to each other. Such mechanical coupling does not, of course, mean that there is no possibility of relative movement between these parts. Such coupling can be achieved by direct or indirect mechanical contact between these parts. In the context of the invention, “mechanical decoupling” logically means an absence of mechanical coupling.

In particular, the mechanical decoupling of the pedals from the chainset corresponds to the mechanical independence of the pedals from each other, and in particular from the translational movement of the pedals relative to each other, which is typically the only movement naturally envisaged for the pedals when the chainset is in use. In short, the pedals are “mechanically decoupled” in that the translational movement of one pedal does not interact with the translational movement of the other pedal.

The use, in this document, of the verb “including”, “provided”, “equipped” and their variants, as well as their conjugations, can in no way exclude the presence of elements other than those mentioned. The use in this document of the indefinite article “a”, “an”, or the definite article “the” to introduce an element does not exclude the presence of a plurality of these elements.

According to a preferred embodiment of the present invention, each of the pedals is mechanically coupled to a toothed wheel by means of a cable secured to the pedal, so that a translational movement of the pedals causes the toothed wheel to rotate. The pedal can be secured to the cable in a simple way using one or more fasteners, possibly by means of a part fixed between the pedal and the cable.

The toothed wheel is a typical gear part used to set a velocipede in motion, as is known to a person skilled in the art. It is preferably designed to be mechanically coupled to at least one support wheel of the velocipede to drive it in rotation. The latter coupling can be made either directly from the toothed wheel, in which case the toothed wheel acts as the chainring, or from another mechanical part of the chainset that acts in this way and is itself mechanically coupled to the toothed wheel. The reference to “one” toothed wheel does not exclude the presence of several such toothed wheels aligned side by side within the chainset, the wheel that is coupled with the pedal being selectable via a derailleur as is well known to the person skilled in the art.

The toothed wheel can also be mechanically coupled to the pedal directly by means of the cable alone, or indirectly via other mechanical elements.

Preferably, the cable comprises a section supporting or constituting a drive chain, the latter meshing with the toothed wheel. The section extends only over a part of a total length of the cable, preferably less than 50% and more preferably less than 30%, for example around 25%. In particular, it is not necessary to fit the entire cable length with such a drive chain.

The use of a cable, particularly in the above preferred embodiment, is advantageous because it is generally lighter, easier to handle and less expensive than a transmission chain. As the movement of the pedals is translational in the context of the present invention, the mechanical coupling of the pedals with the rest of the chainset is likely to require a greater length of chain than a traditional velocipede where the pedals rotate. The use of a cable is therefore particularly advantageous for this purpose.

The cable is made, for example, of metal wires and/or synthetic fibres. As will be readily understood by those skilled in the art, the cable must be resistant to traction and be able to be bent, for example, to form a closed cycle from a pedal. Furthermore, the term “cable” is not to be interpreted restrictively in this respect, as any form of flexible linear element which is equivalent for this purpose can be used as a cable within the scope of the present invention.

Although, according to one embodiment, a section of the cable supports or constitutes a drive chain, the case of a cable which is homogeneous along its length, and without a chain, does not depart from the scope of the invention. Such a cable has the advantage of avoiding the use of a transmission chain within the chainset and therefore simplifying the latter. In such a case, as described with reference to FIG. 4 below, the toothed wheel can be mechanically coupled to the pedal via an axle supporting a drum around which the cable is wound.

For the purposes of this document, a synchronous belt can also be used in place of the aforementioned drive chain, in an equivalent manner.

Preferably, the cable is supported by at least one pulley and is in the form of a closed cycle from the pedal at least partially surrounding the pulley. The pulley is located, for example, at one end of the rectilinear path of the path. The toothed wheel or another guide element, such as another pulley, can then be arranged at the other end of the travel of the pedal, so that the cable also at least partially surrounds the toothed wheel or this other guide element. The pulley has the advantage of making it easier to guide the cable and move it when the pedal moves in translation. It also helps to support the chainset, in particular the cable, and, more generally, the rigidity of the chainset in position.

The closed cycle formed by the cable from the pedal allows simple and efficient implementation of the aforementioned translational pedalling in the form of a back-and-forth movement, typically along a part of the closed cycle. This cycle can be achieved in various ways, for example by attaching each of two opposite ends of the pedal in its direction of movement, respectively to two ends of the cable, or for example by using a cable forming a closed loop to which the pedal is secured at a fastening point, possibly via a part fixed between the pedal and the cable.

According to a preferred embodiment of the invention:
the toothed wheel is arranged to operate in freewheel mode, or
the toothed wheel is mechanically coupled to a mechanical element arranged to operate in freewheel mode, so that a rotational movement of the mechanical element drives the toothed wheel in rotation, the mechanical element being mechanically coupled to one of the pedals, so that a translational movement of this pedal drives the mechanical element in rotation.
   According to this embodiment, there is therefore a freewheeling operation of the toothed wheel or the mechanical element arranged between the toothed wheel and the pedal. This allows, on the one hand, the toothed wheel or the mechanical element (and therefore also the toothed wheel) to be driven in one direction of rotation and, on the other hand, a thrust force exerted by a user on the pedal to be transmitted in one direction of the translational movement (for example, “downward”). On the other hand, freewheeling operation (for example, via a click) also enables the toothed wheel or mechanical element to be rotated in the other direction without resistance, without transmitting force, when the user moves the pedal in the other direction in the direction of translational movement (for example, “upwards”), i.e. when the pedal returns to its position.

The freewheeling operation and its implementation are well known to those skilled in the art and are not described in detail in this document. In particular, they allow simple and practical implementation of translational pedalling.

Advantageously, the above-mentioned embodiment proposes that the toothed wheel does not necessarily itself freewheel, as this function can be implemented by means of the mechanical element. The latter is an intermediate element in the velocipede's transmission. It is particularly useful when several wheels of the velocipede are to be driven by the same toothed wheel (as in the case of the embodiment shown in FIG. 2 below) and/or when the direction of the translational movement or the type of velocipede does not allow the toothed wheel to be arranged appropriately or easily in alignment with this direction (as in the case of the embodiment shown in FIG. 3 below).

In order not to make the chainset unnecessarily complex, the mechanical decoupling of the pedals naturally leads to a mechanical coupling of the mechanical element to just one of the pedals. However, as this mechanical element operates in freewheel mode, the toothed wheel (or a possible block of successive toothed wheels to define several velocipede speeds) to which it is coupled is preferably single. It typically acts as the known chainring (or chainring blocks) of the velocipede, arranged between two mechanical elements as mentioned above, each coupled to one of the pedals. The mechanical element is preferably mounted on a axle secured to the toothed wheel to drive the latter in rotation. This arrangement is also particularly effective and easy to implement for the above purposes.

According to a first embodiment, the toothed wheel is arranged to operate in reverse freewheel mode with respect to the mechanical element, the latter constituting another toothed wheel. This embodiment is particularly advantageous when using a velocipede comprising several wheels to be driven by the chainset (as in the embodiment shown in FIG. 2 below).

According to a second embodiment, the mechanical element constitutes a drum around which a part of the cable is wound, the drum comprising a fixing point of the cable. The cable is then preferably supported by two pulleys and is in the form of a triangular cycle at least partially surrounding each of the pulleys, the pedal being able to move in translation between the two pulleys.

This configuration is particularly advantageous for implementing a bicycle. In this case, the direction of translational movement is at best oblique, or even almost vertical (i.e. essentially perpendicular to a straight line joining the hubs of the two wheels), so that the space available for arranging the mechanical element and its mechanical coupling with the toothed wheel is restricted under the bicycle saddle. It is therefore necessary to modify the velocipede frame to reposition the chainset or increase the height of the saddle. These modifications are a source of technical difficulties and may not allow the user of the bicycle to make pedalling more pleasant and/or not allow them to easily put one foot on the ground if necessary, which is undesirable.

Advantageously, the pulleys allow the pedal to be arranged on the bicycle in such a way as to overcome these difficulties. They allow the drum to be offset laterally with respect to the translational movement and consequently facilitate its mechanical coupling with the toothed wheel acting as a plate, for example via a mechanical axle as described above.

This chainset can be easily integrated into a conventional bicycle by replacing the chainset, without modifying the frame and architecture of the bicycle, which represents a time saving in the large-scale deployment of this invention at minimal cost. In particular, such a replacement can even be made by retaining the existing chainring on the bicycle and using it as the aforementioned toothed wheel to which the drum is mechanically coupled.

The use of a drum is advantageous because it does not require a drive chain and is therefore particularly simple. In particular, when the pedal is moved in translation in one direction (“down” or “up” for example), it drives the cable to which it is secured, the latter unwinding from the drum from one side while it winds around the drum from the other side. Preferably, the cable makes several turns around the drum.

Those skilled in the art will understand that the number of turns of the cable around the drum depends on the diameter of the drum and the desired length of straight-line movement to be covered by the pedal. The fixing point allows this movement to be limited in a simple and appropriate way, while securing the cable to the drum. The cable typically extends on either side of the fixing point. In this way, it can be wound and unwound around the drum without slipping.

According to an embodiment of the invention compatible with the preceding embodiments, each pedal is arranged on a slide. This arrangement is such that the translational movement of the pedal corresponds to a sliding of a trolley of the slide on a rail thereof.

In the context of this document, as it is known to a person skilled in the art, a “slide” is a mechanical part allowing a rectilinear sliding movement, and comprising two parts: a rail and a trolley that moves on bearings inserted into the rail. The terms “rail” and “trolley” are to be interpreted in the mechanical sense of the term. The bearings can be substituted for a slide, for example.

The slide rail in this embodiment is a simple and practical way of implementing the translational movement of the pedal. In particular, the pedal is preferably secured to the trolley of the slide, so that the slide not only allows the pedal to move in a rectilinear line, but also protects and holds the mechanical elements of the chainset in place. In particular, the slide can be positioned and secured in a simple and solid manner to the frame of the velocipede by its rail.

Several projects are planned. In a first such embodiment, the pedal is arranged between two parallel rails and secured to either side to two rollers, each positioned on one of the rails. The translational movement of the pedal then takes place between the two rails. The pedal can also be secured to two other offset rollers (for example, behind the forward trajectory or “downward” trajectory of the pedal) relative to the first two arranged under the rail. This increases the grip of the pedal connected to the wheels on the rails, thereby improving the stability of the chainset. Where the chainset includes a cable associated with each pedal as described above, a part of the cable extends parallel to and between the two rails.

In a second embodiment, the pedal is secured to a (small) trolley comprising at least two, and preferably four, rollers arranged in a single rail in the form of a case with a slot. A mechanical link in the form of a rod, for example a bracket, secures the pedal to the trolley through the slot, allowing the trolley, link and pedal to move in translation parallel to the rail.

In the second embodiment, and generally according to the embodiments in which a slide rail and a cable are associated with each pedal as described above, a part of the cable is preferably arranged in the slide and extends between two ends of the latter. In particular, the rail of the slide advantageously guides the cable and pedal, protecting the mechanical elements associated with them as shown in FIG. 4 below.

In the embodiments shown, the mechanical parts such as the cable, the drive chain, the pulleys, the mechanical element and the slide belong to the chainset according to the invention and are preferably associated with only one of the pedals. The toothed wheel belongs to the chainset, acts as a chainring as described above (or as a block of chainrings if several such toothed wheels are provided side by side to define several speeds) which may be unique for both pedals as is the case for the embodiments illustrated in FIGS. 2 and 3 introduced below.

There are, however, other embodiments, such as that illustrated in FIG. 1 below, in which each of the pedals is associated with a separate toothed wheel. This is also a very simple way of implementing mechanical decoupling of the pedals.

The embodiments with one (or more) toothed wheels playing the role of a single chainring (or block of chainrings) known from a conventional velocipede have the advantage, however, of being easy to install on a velocipede while retaining its chainring, as only the other mechanical parts of the chainset have to be replaced by those according to this invention. For example, for a traditional bicycle, the rest of the transmission mechanism that is coupled to the chainset (i.e. a transmission chain meshing with the toothed wheel and a pinion mechanically coupled to a hub of a rear support wheel provided with a possible derailleur) can be retained. The chainset according to the invention is therefore easy to integrate into a traditional velocipede without requiring any major modifications.

The invention therefore also logically proposes a velocipede fitted with the chainset according to the present invention. The embodiments and advantages of the chainset of the invention apply mutatis mutandis to the present velocipede.

In particular, the velocipede makes human-powered travel more pleasant, quicker and more efficient than the traditional bicycle.

The velocipede typically comprises a rear support wheel, a front support wheel, and a chainset according to the invention mechanically coupled to the rear support wheel, so that a translational movement of the pedals drives the rear support wheel in rotation. In other words, the chainset is arranged to rotate the rear support wheel.

Preferably, for a chainset fitted with a cable coupled to a toothed wheel as introduced above, the toothed wheel is mechanically coupled to the rear support wheel, so that a rotational movement of the toothed wheel drives the rear support wheel in rotation. In this case, and preferably, a transmission chain meshes with the toothed wheel and a pinion mechanically coupled to a hub of the rear support wheel. As described above, these elements of the transmission mechanism are known from a common velocipede and the chainset according to the invention advantageously allows it to be coupled simply and efficiently with this mechanism without having to modify it or change the rest of the architecture of the velocipede.

According to an embodiment of the velocipede according to the invention corresponding to a bicycle, for example illustrated in FIG. 3 hereafter introduced, the translational movement of the pedals is in a direction forming a smaller angle of between 60 and 90°, preferably between 70° and 80°, for example, 70, 75° or 80°, with a direction passing through the hub of the rear support wheel and a hub of the front support wheel. The user's legs are arranged in much the same way as on a conventional bicycle, with only their movement being distinct, being a back and forth translational movement, typically from “top to bottom” and “bottom to top” as described above.

The chainset is preferably configured so that it is the user's “downward” push that induces rotation of the toothed wheel, while the “upward” return movement does not induce reverse rotation of the toothed wheel thanks to a freewheel operating mechanism (of the toothed wheel or of the mechanical element interposed between each pedal and the toothed wheel) as described in detail above. Advantageously, the user can easily transmit force to the chainset and transmission mechanism because it is easy to push the pedal “down”. Furthermore, this force can be doubled in the context of the invention, as the pedals are mechanically decoupled.

According to an embodiment of the velocipede corresponding for example to a tricycle or a quadricycle, for example illustrated in FIG. 2 hereafter introduced, the velocipede comprises two rear support wheels and an axle extending between the hubs thereof. The pinion is preferably mounted on a differential arranged at the axle. Advantageously, the differential allows the rear support wheels to rotate at different speeds, for example when the velocipede approaches a bend.

When the velocipede is a tricycle, as is known, the support wheels are preferably arranged in an isosceles triangle, with the front support wheel being central as in FIGS. 1 and 2 below. The invention can also be applied to tricycles with a driven rear wheel and two steered front wheels, as well as to recumbent bicycles. In the latter two cases, the chainset is a variant of FIG. 4, with the slide rail approaching a horizontal direction.

The pedals move in translation in a direction that preferably makes an angle of at most 15° with a direction perpendicular to the axle passing through a hub of the front support wheel. The direction of travel is therefore approximately parallel to the direction through the hub of the front support wheel and perpendicular to the rear axle. It is therefore also parallel to the overall orientation of the velocipede and the direction in which it is moving. The cables to which the pedals are secured, if applicable, are then arranged in the same direction, as are any slides.

The pedalling motion on a tricycle like this is more comfortable than on a traditional tricycle, particularly given the extended position of the user's legs, allowing their torso to remain upright and perpendicular to the direction of travel. This position of the user's body is perfectly suited to pedalling in translation while having a good view of the trajectory to be covered by the tricycle. The translation movement is then a “forwards” and “backwards” movement.

The chainset is preferably configured in such a way that it is the user's “forward” thrust that forces rotation (of the axis of) the toothed wheel, while the “backward” return movement only induces “idle” rotation of the toothed wheel thanks to a freewheel operating mechanism described in detail above. Advantageously, the user can easily transmit force to the mechanism of the chainset and transmission of the tricycle because it is easy for him to push the pedal “forward”. Furthermore, this force can be doubled in the context of the invention, as the pedals are mechanically decoupled.

Although pedalling in translation is generally and preferably carried out using the user's lower limbs, in the case of the tricycle presented above, it can also be carried out using the user's upper limbs. This is easily achieved by adjusting the height of the pedals, cables, pulleys and/or any slide, so that the pedals are arranged to be set in translational motion by upper human limbs.

The advantages of pleasant pedalling mentioned above are then transposed to this tricycle, in particular because pedalling does not strain the user's shoulders, unlike equivalent devices with rotating pedalling. The user can keep his torso fixed and straight and move only his arms. This embodiment is highly advantageous for users with reduced or no mobility in their lower limbs.

### BRIEF DESCRIPTION OF THE FIGURES

Other characteristics and advantages of the present invention will become apparent from the following detailed description, reference to which will be made to the attached figures, including:

FIG. 1 shows a schematic view of a tricycle fitted with a chainset according to a first embodiment of the invention;

FIG. 2 shows a schematic view of a tricycle fitted with a chainset according to a second embodiment of the invention;

FIG. 3 shows a schematic view of a bicycle fitted with a chainset according to a third embodiment of the invention;

FIG. 4 shows a schematic view of a part of the chainset shown in FIG. 3.

The drawings in the figures are not to scale. Similar elements are generally denoted by similar references in the figures. In the scope of this document, the same or similar elements may have the same references. Furthermore, the presence of reference numbers or letters in the drawings cannot be regarded as limiting, even if these numbers or letters are indicated in the claims.

### DESCRIPTION OF EMBODIMENTS OF THE INVENTION

This part describes preferred embodiments of the present invention. The latter is described with particular embodiments and references to figures but the invention is not limited by them.

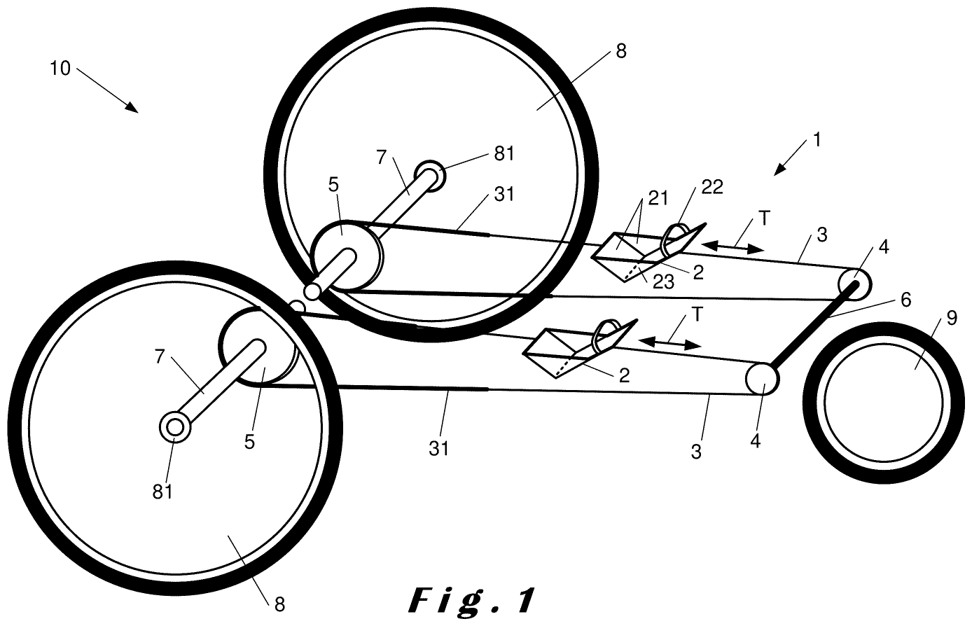

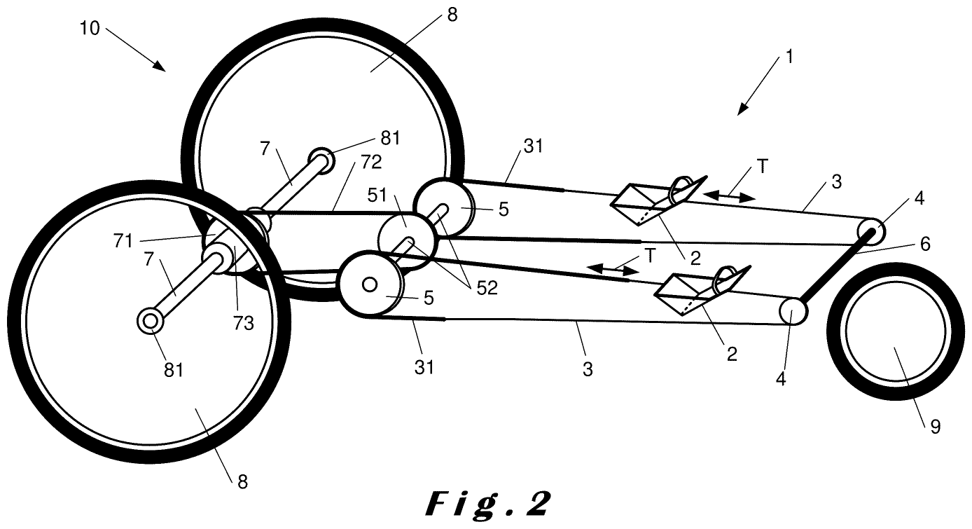

The drawings and figures described below are schematic but not restrictive. In particular, FIGS. 1 and 2 obviously do not include all the mechanical elements of a velocipede well known to the person skilled in the art, but are limited to representing the essential elements thereof linked to the operation of the chainset according to the invention.

FIG. 1 partially illustrates a tricycle 10 fitted with a chainset 1 according to a first embodiment of the invention. The chainset 1 comprises two pedals 2 that can be moved in translation T in a “horizontal” direction and are mechanically decoupled from each other. The tricycle 10 has two rear support wheels 8 and a front support wheel 9 arranged centrally in relation to the two rear support wheels 8 as is known from a conventional tricycle. However, the two rear support wheels 8 are not secured directly to the same axle, but to separate axle portions 7 each extending between a hub 81 of a rear support wheel 8, possibly fitted with a derailleur.

Each axle portion 7 is coupled axially and mechanically to a toothed wheel 5 capable of freewheeling. Each of the toothed wheels 5 is directly mechanically coupled to one of the pedals via a cable 3 which comprises, over a section of for example approximately 30% of its total length, a drive chain 31 meshing with the toothed wheel 5. Alternatively, this embodiment can be defined as a free drive chain 31 to the ends of which a closed-cycle cable is secured. A pulley 4 guides and supports the cable 3 in a closed cycle.

In particular, the cable 3 extends, on the one hand, over a horizontal section, from the toothed wheel 5 to the pulley 4 and, on the other hand, over another horizontal section opposite the first, from the pulley 4 to the toothed wheel 5. The cable partly surrounds the pulley 4, which enables the drive chain 31 to be brought back into position at the toothed wheel 5 by a translational movement T of the cable. This translational movement is induced by one of the pedals 2 secured to the cable so that a translational movement T of the pedal 2 “forwards”, i.e. from the toothed wheel 5 towards the pulley 4, forces the axle 7 of the toothed wheel 5 to rotate. A translational movement T of the pedal 2 in the other direction, i.e. “backwards”, from the pulley 4 towards the toothed wheel 5, will have the effect of inducing an “idle” rotation of the toothed wheel 5 as the latter is freewheeling.

Although not shown in FIGS. 1 and 2, each pedal 2 can be guided in translation T by means of a slide as described in the description of the invention.

Each side of the chainset 1 on either side of the direction defined by the translational movement T, and more generally of the mechanism illustrated for the tricycle 10, is independent and mechanically decoupled from the other. In this way, one of the rear support wheels 8 can be rotated independently of the other by moving the corresponding pedal 2. This embodiment is therefore very easy to use and provides a pleasant pedalling experience with high efficiency.

Various structural elements 6 and a frame or chassis of the tricycle 10 (such as the pulley retaining element 4 in FIGS. 1 and 2) are not necessarily shown. However, they are obviously intended to hold the pieces of the tricycle 10 together, as the skilled person will understand.

FIG. 2 partially illustrates a tricycle 10 provided with a chainset 1 according to a second embodiment of the invention. The difference with the first embodiment is that the two toothed wheels 5 are no longer each coupled directly to one of the rear support wheels 8, but are mounted on the same axle 52 on either side of another toothed wheel 51 (or group of toothed wheels) arranged to operate in reverse freewheel mode relative to the toothed wheels 5. This other toothed wheel 51 plays a role similar to that of a chainring of a traditional velocipede, while the toothed wheels 5 play the role of intermediate mechanical elements as described in the description of the invention.

The principle of the pedalling is the same in both embodiments. It is the transmission of the rotational movement from the toothed wheels 5 to the rear support wheels 8 that is distinct. The translational movement T of the pedals 2 “forwards” following a push causes the toothed wheels 5 to rotate. As they are mechanically coupled to the other centrally arranged toothed wheel 51 via the axle 52, they also impart a rotational movement to the latter, with twice the power if both pedals 2 are moving “forward” at the same time.

A translational movement T of the pedals 2 in the other direction, “backwards”, to return them to the position for applying the above-mentioned thrust, will have the effect of not inducing rotation of the toothed wheel 51, as the two toothed wheels 5 operate in freewheel mode.

In this second embodiment, the energy is transmitted between the pedals 2 and the rear support wheels 8 via this other toothed wheel 51, by a transmission chain 72 meshing with a pinion 71 arranged on an axle 7 of the two wheels in question, in a completely standard manner. The pinion 71 is mounted on a differential 73 arranged in the centre of the axle to allow the rear support wheels 8 to rotate at different speeds, which is particularly useful when the tricycle approaches a bend.

As illustrated in FIG. 1, the pedals 2 of the chainset 1 according to the invention are preferably each provided with a support surface 23 designed to accommodate a user's foot. This support surface 23 can be textured and/or padded for added comfort. A lateral edge 21 and/or a heel piece of the pedal 2 is preferably provided to adequately stabilise the foot and facilitate the return movement of the pedals 2 from the pulley to the toothed wheel 5. A flexible and adjustable portion 22 on top of the support surface 23, for example in the form of a belt or elastic band, is preferably provided to attach the foot to the pedal 2 in a more stable manner and allow the transmission of the user's force on the pedal 2 to the rest of the chainset 1.

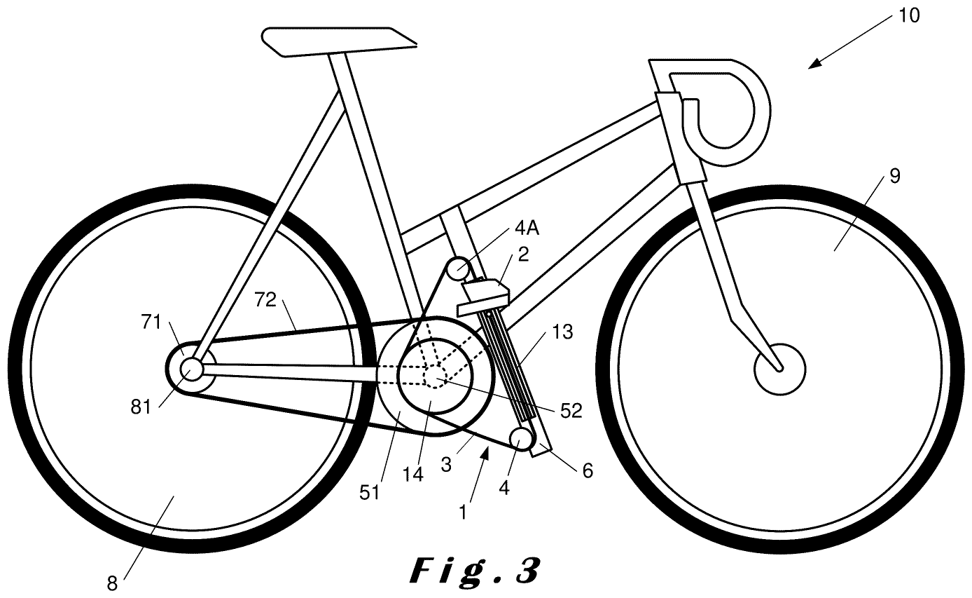

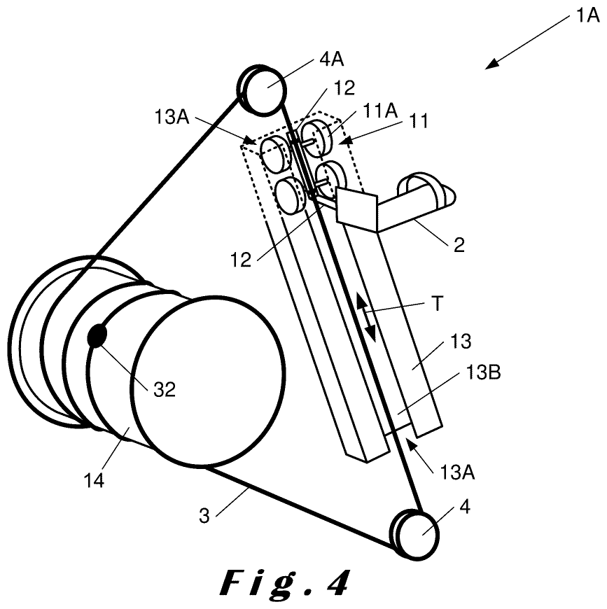

FIG. 3 illustrates a preferred embodiment of the present invention. This is a bicycle 10 to which the chainset 1 comprising two mechanically decoupled pedals 2 has been incorporated in accordance with the invention. FIG. 4 shows a more detailed enlarged view of a side half 1A of the chainset 1 arranged on one side of the bicycle. The arrangement of the chainset 1 on the opposite side is typically similar (“mirrored”), as will be readily understood by those skilled in the art.

Similar to the second embodiment, the rear support wheel 8 of the bicycle is driven in rotation by a mechanical coupling with a toothed wheel 51 effected by means of a transmission chain 72 meshing both in this toothed wheel 51 and in a pinion 71 which is arranged at the hub 81 of the rear support wheel 8. As is known, a derailleur can be provided at this location or a gear change can be included in the hub 81.

The toothed wheel 51 is driven in rotation by its mechanical coupling with two similar examples of the parts illustrated in FIG. 4, arranged on either side of the bicycle 10. More precisely, the toothed wheel 51 is arranged on an axle 52 on which is mounted, on either side of the toothed wheel 51, two drums 14 configured to operate as freewheels, so as to transmit a rotational movement to the toothed wheel 51 via the axle 52 only when they rotate in a direction associated with a “downward” push of the pedals 2 of the bicycle 10.

Each drum 14 accommodates a cable 3 which is guided via two pulleys 4, 4A in a guide rail 13, so that it crosses the rail 13 between two opposite ends 13A of the latter arranged respectively close to one of the pulleys 4, 4A. In particular, the cable 3 follows a triangular cycle between the vertices defined by the drum 14 and the pulleys 4, 4A. The cable 3 is secured to the drum 14 at a fixing point 32 and makes several turns around the drum 14 so that it can be unwound and wound around it.

The cable 3 is also secured to a trolley 11 of the slide comprising ball bearings 11A arranged in the rail 13, so that the trolley 11 can move parallel to the rail, on it. The trolley 11 comprises or is secured to a body 12 including an end segment to which the cable 3 is secured and another opposite end segment to which one of the pedals 2 is secured as shown in FIG. 4. The L-shape allows pedal 2 to be moved out of the path of the trolley, making pedalling easier. A slot 13B is provided on the rail 13 in the direction of translation T to allow a leg of the body 12 to pass out of the rail 13 at any point on the rail 13.

A translational movement T of the pedal 2 corresponds to a movement of the trolley 11 on the rail 13, and therefore to a movement of the cable 3. When the pedal 2 is pushed “down”, i.e. from the pulley 4A to the pulley 4, the cable from the pulley 4A unwinds from the drum 14 and is directed towards the pulley 4A, and the cable from the pulley 4 wraps around the drum 14. The rotational movement of the drum 14 is transmitted to the toothed wheel 51, thus driving the rear support wheel 8 of the bicycle 10 in rotation. When the pedal 2 is pulled “up” to return to the starting point of application of the thrust, i.e. from the pulley 4 to the pulley 4A, the reverse movement occurs but the freewheeling drum transmits no force to the toothed wheel 51. This also enables the pedal 2 to be pulled without effort or resistance, and therefore quickly, so that a further downward push on the pedal 2 can be applied more quickly.

As the two pedals 2 are mechanically independent, the time taken for one of the pedals 2 to return to its position does not depend on the time taken to push the other pedal 2 to a position corresponding to one end 13A of the rail, and each pedal 2 can return to its “up” position in less time than the time taken to push it “down”. In addition, this independence allows both pedals 2 to be pushed at the same time (but not necessarily simultaneously) when using the bicycle 10 according to the invention, and therefore to transmit more power to the toothed wheel 51 as a function of time.

The rail 13 of the slide can advantageously be secured to a frame of the bicycle 10, for example by any mechanical assembly or by securing a support axle 6 as shown in FIG. 3 by welding, or directly to an existing axle of the frame of the bicycle 10. The pulley 4A is preferably firmly anchored to the frame or to this axle 6, as it is subject to greater thrust forces than the pulley 4, which is subject to less stress. As with the other embodiments, the usual structural parts of the bicycle 10, such as the frame, handlebars, saddle, etc., visible in FIG. 3, are not detailed here. These parts are well known to those skilled in the art.

The direction in which the rail 13 extends mainly defines the direction of the translational movement T. It preferably forms an angle of between 60° and 90° with the direction passing through the hub 81 of the rear support wheel 8 and the hub of the front support wheel 9, inducing pleasant pedalling and adequate physical support for the body of the user of the bicycle 10.

Other embodiments than those illustrated are possible and can be easily obtained by the person skilled in the art. For example, in the case of a recumbent bicycle or a tricycle with a single driven rear wheel, the rail 13, and therefore the direction of translation T of the pedals 2, will logically approach a horizontal direction. In this case, the pulley 4A may be omitted, with the cable 3 entering directly into the rail 13.

In summary, the present invention relates to a chainset 1 for a velocipede 10 comprising two mechanically decoupled pedals 2 that can move in translation T.

The present invention has been described above in relation to specific embodiments, which are purely illustrative and should not be regarded as limiting. It will be readily apparent to the person skilled in the art that the invention is not limited to the examples illustrated or described above, and that its scope is more broadly defined by the claims hereinafter introduced.

1-18. (canceled)

19. A chainset for a velocipede equipped with two pedals which are mobile in translation mechanically decoupled from each other,
wherein each of the pedals is mechanically coupled to a toothed wheel by means of a cable secured to the pedal, the toothed wheel being mechanically coupled to a drum arranged to operate in freewheel mode, and
wherein a part of the cable is wound around the drum, the latter comprising a fixing point of the cable.

20. The chainset according to claim 19, wherein the drum is mounted on an axle secured to the toothed wheel to drive the latter in rotation.

21. The chainset according to claim 19, wherein the cable is supported by two pulleys and is in the form of a triangular cycle at least partially surrounding each of the pulleys, the pedal being able to move in translation between the two pulleys.

22. The chainset according to claim 19, wherein each pedal is arranged on a slide.

23. The chainset according to claim 22, wherein a part of the cable is arranged in the slide and extends between two ends thereof.

24. A velocipede comprising a rear support wheel, a front support wheel, a chainset according to claim 19 mechanically coupled to the rear support wheel, so that a translational movement of the pedals drives the rear support wheel in rotation,
wherein the toothed wheel is mechanically coupled to the rear support wheel, so that a rotational movement of the toothed wheel drives the rear support wheel in rotation.

25. The velocipede according to claim 24, comprising a transmission chain meshing with the toothed wheel and with a pinion mechanically coupled to a hub of the rear support wheel.

26. The velocipede according to claim 24, consisting of a bicycle, and wherein the translational movement of the pedals is in a direction forming a smaller angle of between 60 and 90° with a direction passing through the hub of the rear support wheel and a hub of the front support wheel.
